(19) United States
(12) Patent Application Publication
(10) Pub. No.: US 2024/0209565 A1
(43) Pub. Date: Jun. 27, 2024

(54) APPLICATIONS OF AHESIVE PATTERNS FOR FABRIC BONDING AND FABRIC ARTICLES CREATED THEREBY

(71) Applicant: NORDSON CORPORATION, WESTLAKE, OH (US)

(72) Inventors: Laurence Saidman, Duluth, GA (US); Raymond J. Slattery, III, Akron, OH (US)

(73) Assignee: NORDSON CORPORATION, WESTLAKE, OH (US)

(21) Appl. No.: 18/555,622

(22) PCT Filed: Nov. 12, 2021
(86) PCT No.: PCT/US2021/059065

§ 371 Date: Oct. 16, 2023

Related U.S. Application Data
(60) Provisional application No. 63/112,744, filed on Nov. 12, 2020.

(51) Int. Cl. D06M 17/04; C09J 5/00

(52) U.S. Cl. CPC D06M 17/04; C09J 5/00; C09J 2400/263

(57) ABSTRACT

In examples, a method of bonding portions of fabric to one another includes dispensing a plurality of liquified adhesive spots onto a first fabric portion so that the plurality of liquified adhesive spots are spaced apart from one another and applying a second fabric portion to the adhesive spots to adhere the second fabric portion to the first fabric portion. In examples, the spacing defines a plurality of unbonded gaps between the adhesive spots. In examples, the adhesive spots are dispensed along a length so that the adhesive spots are spaced along a dispensed line requiring at least 30% less adhesive as compared to a solid line having the same length. In examples, a fabric article includes a first fabric portion having adhesive spots spaced apart from one another and a second fabric portion adhered to the first fabric portion by the adhesive spots.

### CROSS REFERENCE TO RELATED APPLICATIONS

This application is a National Stage Application of International Patent App. No. PCT/US2021/059065, filed Nov. 12, 2021, which claims the benefit of U.S. Provisional Patent App. No. 63/112,744, filed Nov. 12, 2020, the entire disclosures of both of which are hereby incorporated by reference as if set forth in their entirety herein.

### TECHNICAL FIELD

The present disclosure relates to methods for bonding portions of fabric to one another, in particular, to adhering portions of fabric to one another by liquified adhesive formations (e.g., spots) and articles created thereby.

### BACKGROUND

In the garment manufacturing field, a material, such as a polyurethane (PUR) glue, is commonly applied to a fabric or cloth for binding pieces of the fabric or cloth together. When bonding pieces of fabric together, the ability to apply a small amount of a material with a high degree of accuracy and precision is desirable. In many cases, this is achieved with an adhesive tape (e.g., a thermoplastic film tape that is activated by heat by being pinched between hot rollers to form a bond), but this is typically not as flexible or pliable as the underlying fabric substrate. For example, the width of the desired strip of material to be applied to a fabric can have requirements of less than 8 mm in width and less than 0.2 mm in height. In many currently existing methods, material is sprayed with low levels of accuracy and precision, which can result in the spraying of excessive amounts of material. Further yet, due to the difficulty associated with creating the desired pattern of dispensed material, an insufficient amount of material is often applied to the fabric, resulting in an insufficient bond. If more material is desired, separate application processes are run, which undesirably results in longer manufacturing times, increased machinery wear, and added costs.

Therefore, there is a need for adhesive bonding patterns for fabrics without requiring excess amounts or application times.

### SUMMARY

In an example, a method of bonding fabrics to one another is provided. The method includes dispensing a plurality of liquified adhesive spots onto a first fabric portion. The plurality of liquified adhesive spots are dispensed onto the first fabric portion so that individual ones of the plurality of liquified adhesive spots are spaced apart from one another. The plurality of liquified adhesive spots are spaced apart from one another so as to define a plurality of unbonded gaps between the adhesive spots. The first fabric portion has longitudinal fibers and transverse fibers. A portion of at least one longitudinal fiber, a portion of at least one transverse fiber, or a portion of at least one longitudinal fiber and a portion of at least one transverse fiber extends through each of the unbonded gaps and is unbonded by liquid adhesive. The method further includes applying a second fabric portion to the plurality of liquified adhesive spots dispensed onto the first fabric portion. The second fabric portion is applied to the plurality of liquified adhesive spots dispensed onto the first fabric portion so as to adhere the second fabric portion to the first fabric portion.

In another example, another method of bonding fabrics to one another is provided. The method includes dispensing a plurality of liquified adhesive spots onto a first fabric portion. The plurality of liquified adhesive spots are dispensed onto the first fabric portion along a length. The plurality of liquified adhesive spots are dispensed onto the first fabric portion along a length so that individual ones of the plurality of liquified adhesive spots are spaced from one another. Individual ones of the plurality of liquified adhesive spots are spaced from one another along a dispensed line. The dispensed line requires at least 30% less adhesive as compared to a solid line having the same length. The method further includes applying a second fabric portion to the plurality of liquified adhesive spots dispensed onto the first fabric portion. The second fabric portion is applied to the plurality of liquified adhesive spots dispensed onto the first fabric portion so as to adhere the second fabric portion to the first fabric portion.

In a further example, another method of bonding fabrics to one another is provided. The method includes dispensing a plurality of liquified adhesive spots onto a first fabric portion. The plurality of liquified adhesive spots are dispensed onto the first fabric portion so that individual ones of the plurality of liquified adhesive spots are spaced apart from one another. The plurality of liquified adhesive spots are spaced apart from one another along a first direction. The first fabric portion has longitudinal fibers and transverse fibers. The first direction is aligned with either the longitudinal fibers or the transverse fibers. The method further includes applying a second fabric portion to the plurality of liquified adhesive spots dispensed onto the first fabric portion. The second fabric portion is applied to the plurality of liquified adhesive spots dispensed onto the first fabric portion so as to adhere the second fabric portion to the first fabric portion.

Another example is a fabric article. The fabric article includes a first fabric portion. The first fabric portion has longitudinal fibers and transverse fibers. The first fabric portion has a plurality of liquified adhesive spots dispensed thereon. The plurality of adhesive spots are spaced apart from one another. The plurality of adhesive spots are spaced apart from one another so as to define a plurality of unbonded gaps between the adhesive spots. A portion of at least one longitudinal fiber, a portion of at least one transverse fiber, or a portion of at least one longitudinal fiber and a portion of at least one transverse fiber extends through each of the unbonded gaps and is unbonded by adhesive. The fabric article further includes a second fabric portion. The second fabric portion is adhered to the first fabric portion. The second fabric portion is adhered to the first fabric portion by the plurality of adhesive spots.

In another example, another method of bonding fabrics to one another is provided. The method includes dispensing a first plurality of liquified adhesive spots onto a first fabric portion. The first plurality of liquified adhesive spots are dispensed onto the first fabric portion so that individual ones of the first plurality of liquified adhesive spots are spaced apart from one another. The first plurality of liquified adhesive spots are spaced apart from one another along a first direction. The first plurality of liquified adhesive spots are spaced apart from one another so as to define a first plurality of unbonded gaps between the first plurality of liquified adhesive spots. The method further includes dispensing a second plurality of liquified adhesive spots onto the first fabric portion. The second plurality of liquified adhesive spots are dispensed onto the first fabric portion so that individual ones of the second plurality of liquified adhesive spots are spaced apart from one another. The second plurality of liquified adhesive spots are spaced apart from one another along the first direction. The second plurality of liquified adhesive spots are spaced apart from one another so as to define a second plurality of unbonded gaps between the second plurality of liquified adhesive spots. Individual ones of the second plurality of liquified adhesive spots are spaced apart from individual ones of the first plurality of liquified adhesive spots. Individual ones of the second plurality of liquified adhesive spots are aligned with individual ones of the first plurality of unbonded gaps. The method further includes applying a second fabric portion to the first and second pluralities of liquified adhesive spots dispensed onto the first fabric portion. The second fabric portion is applied to the first and second pluralities of liquified adhesive spots dispensed onto the first fabric portion so as to adhere the second fabric portion to the first fabric portion.

### BRIEF DESCRIPTION OF THE DRAWINGS

The following description of the illustrative examples may be better understood when read in conjunction with the appended drawings. It is understood that potential examples of the disclosed systems and methods are not limited to those depicted.

FIG. 1 shows a side view of an applicator system for applying liquified adhesive spots to a substrate according to one example;

FIG. 2A shows a top view of a fabric having longitudinal and transverse fibers according to one example;

FIG. 2B shows a top view of the fabric of FIG. 2A with a plurality of adhesive spots dispensed thereon according to one example;

FIG. 2C shows a top view of the fabric of FIG. 2A with a plurality of adhesive spots dispensed thereon according to one example;

FIG. 2D shows a top view of the fabric of FIG. 2A with a plurality of adhesive spots dispensed thereon according to one example;

FIG. 3A shows a top view of a woven fabric having a warp and a weft according to one example;

FIG. 3B shows a top view of the woven fabric of FIG. 3A with a plurality of adhesive spots dispensed thereon according to one example;

FIG. 3C shows a top view of the woven fabric of FIG. 3A with a plurality of adhesive spots dispensed thereon according to one example;

FIG. 3D shows a top view of the woven fabric of FIG. 3A with a plurality of adhesive spots dispensed thereon according to one example;

FIG. 4A shows a top view of a knitted fabric having courses and wales according to one example;

FIG. 4B shows atop view of the knitted fabric of FIG. 4A with a plurality of adhesive spots dispensed thereon according to one example;

FIG. 4C shows a top view of the knitted fabric of FIG. 4A with a plurality of adhesive spots dispensed thereon according to one example;

FIG. 4D shows a top view of the knitted fabric of FIG. 4A with a plurality of adhesive spots dispensed thereon according to one example;

FIG. 5A shows a top view of a single piece of fabric including a first fabric portion with a plurality of liquified adhesive spots dispensed thereon and a second fabric portion according to one example, the first and second fabric portions being integral to one another;

FIG. 5B shows a top view of separate and distinct pieces of fabric including a first fabric portion with a plurality of liquified adhesive spots dispensed thereon and a second fabric portion according to one example;

FIG. 5C shows an end view of an article created by bonding portions of fabric to one another by a plurality of adhesive spots according to one example;

FIG. 6 shows a variety of patterns for adhesive spots according to one example;

FIG. 7 shows a graph illustrating the strength of some of the adhesive spot patterns shown in FIG. 6 according to one example; and

FIG. 8 shows a graph illustrating the effect of mass per liquified adhesive spot on the adhesive effectiveness.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “longitudinal” and “transverse” designate directions in the drawings to which reference is made. The term “substantially” is intended to mean considerable in extent or largely but not necessarily wholly that which is specified. The term “substantially parallel” should be construed in its lay sense of two directions or surfaces that maintain a generally constant distance between them, such as directions or surfaces that are within about 20 degrees of being parallel, such as within about 15 degrees, such as within about 10 degrees, such as within about 5 degrees, and, in particular, should not be construed in the strict mathematical sense that such directions or surfaces will never intersect when extended to infinity. In addition, “substantially perpendicular” should be construed in its lay sense of two directions or surfaces that maintain a generally constant distance between them, such as directions or surfaces that are within about 20 degrees of being perpendicular, such as within about 15 degrees, such as within about 10 degrees, such as within about 5 degrees, and, in particular, should not be construed in the strict mathematical sense that such directions or surfaces remain precisely 90 degrees offset from one another when extended to infinity. The terminology includes the above-listed words, derivatives thereof, and words of similar import.

While conventional bonding patterns and articles created thereby have been adequate for their intended purpose, there is a need for bonding patterns that provide strong, durable bonds (e.g., that are wash-resistant) for fabric utilizing an optimum amount of adhesive (e.g., using the minimal amount of adhesive necessary to achieve a desired bond strength and feel) while maintaining desired fabric properties (e.g., “hand” and softness). The bonding patterns described herein may be selected to balance both the strength of the bond and “hand” (i.e., feel of the fabric) by selecting the amount of adhesive needed to achieve a desired strength bond strength and a desired feel of the bond site.

The bonding patterns of the present disclosure can be used in a variety of applications as will be readily appreciated by those skilled in the art. By way of non-limiting example, it is contemplated that the foregoing may be used to create articles (e.g., garments).

Described herein are bonding patterns defined by a plurality of adhesive formations (e.g., spots). The adhesive formations or spots may be dispensed or otherwise applied or disposed onto a substrate 200 by, for example, an applicator system 10. The substrate 200 may include one or more fabric portions onto which the plurality of adhesive formations may be dispensed.

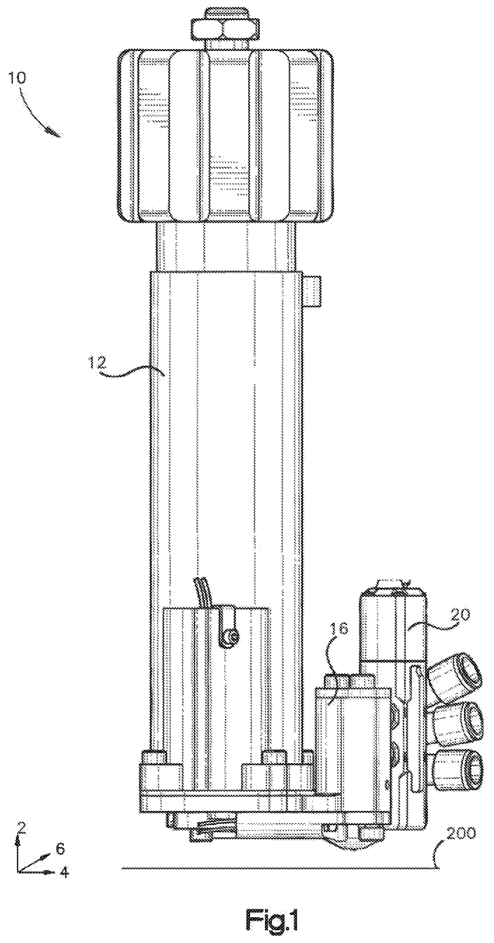

Referring first to FIG. 1, an example applicator system 10 is shown. As depicted, the applicator system 10 may include a material supply 12 for storing a supply of material. In certain examples, the material may be a glue, such as polyurethane (PUR) glue, or thermoplastic hot melt, or pressure sensitive adhesive (PSA), or another adhesive having sufficient cohesive strength and “open time” as described herein, though other materials are contemplated. The material supply 12 may be configured to melt and/or maintain the material at an elevated temperature while it remains within the material supply 12. Thus, in some examples, the applicator system 10 may be referred to as a hot melt applicator and the material dispensed from the applicator system 10 may be referred to as a hot melt (e.g., a hot melt adhesive). In some examples, the material supply 12 may be designed to hold up to 300 cubic centimeters (cc) of material, though the material supply 12 can be larger or smaller as desired. The material supply 12 can include a heating element (not shown) to provide heat to the material within the material supply 12, or, alternatively, to maintain a desired temperature within the material supply 12. This may prevent the material from cooling when it is being dispensed, thus preserving the desired material flow properties. In some examples, the applicator system 10 may include a second heating element (not shown) that is configured to maintain the material (e.g., adhesive) at a different temperature than the heating element described above.

As may be appreciated by those skilled in the art, the applicator system 10 may be configured to operate so as to dispense the material (e.g., adhesive) onto the substrate 200. In certain examples, a discrete volume of the material may be forcefully ejected (e.g., jetted) from the applicator system 10 (e.g., from a nozzle thereof) towards the substrate 200. Jetting is contrasted with extrusion or other types of material dispensing, where liquid material is dispensed as a continuous, elongate filament, generally referred to as a “bead” of adhesive. While drops can be formed by rapidly opening and closing a valve during extrusion of liquid material, or by using air to break up an extruded bead as it is dispensed, these processes are distinctly different from jetting processes, in which the discrete liquid mass is rapidly ejected directly from the applicator system 10 at a high velocity. The liquid material (e.g., adhesive) may be jetted from the applicator system 10 at a higher pressure than it is received into the applicator system 10. In this way, in some examples, a portion of the liquid material (e.g., in the form of a droplet or a dot) may break away from the applicator system 10 (e.g., from a nozzle thereof). In such examples, the jetted material may be separated from the applicator system 10 (e.g., from a nozzle thereof) before contacting the substrate 200.

As may be further appreciated by those skilled in the art, the applicator system 10 may be configured such that a single stroke (e.g., defined by the transition of a firing pin from a retracted position to an extended position and then from the extended position back to the retracted position) may result in the dispensing of a plurality of liquified adhesive formations from the applicator system 10 (e.g., from a nozzle thereof) onto the substrate 200. It will be understood that the stroke length, the amount of material present in the applicator system 10, the pressure under which the adhesive is dispensed or otherwise applied or disposed, and the number and dimensions of outlet channels of the applicator system 10 are all parameters that can be modified to achieve desired dispensing characteristics and/or patterns. By way of non-limiting example, with each stroke, one or more distinct and separate liquified adhesive formations may be dispensed (e.g., jetted) from the applicator system 10 (e.g., from a nozzle thereof) onto the substrate 200. It is specifically contemplated that each stroke may result in the dispensing of one, two, three, four, or more than four distinct and separate adhesive formations. Dispensing a plurality of distinct and separate liquified adhesive formations with each stroke advantageously allows for simultaneous dispensing of more material, thereby resulting in decreased manufacturing time and associated costs. By way of further non-limiting example, the stroke length may be about 1.5 mm. By way of further non-limiting example, the plurality of adhesive formations may be dispensed or otherwise applied or disposed at about 5.5 bar pneumatic pressure.

While FIG. 1 shows an example applicator system 10 for dispensing the bonding patterns described herein, it is to be understood that such bonding patterns can be applied in any of a variety of suitable manners, and the bonding patterns and methods for applying the same as described herein are not limited to being dispensed by any specific applicator system. Thus, bonding patterns of the present disclosure can be applied by any suitable applicator system, not just the system shown in FIG. 1.

As will be described in greater detail herein, the dispensing or bonding pattern may be selected to balance both the strength of the bond and “hand” (i.e., feel of the fabric). Thus, the pattern may be selected by selecting the amount of adhesive needed to achieve a desired bond strength and a desired feel of the bond site. The desired dispensing or bonding pattern may depend on the specific substrate, application use, material being dispensing, and/or other manufacturing patterns.

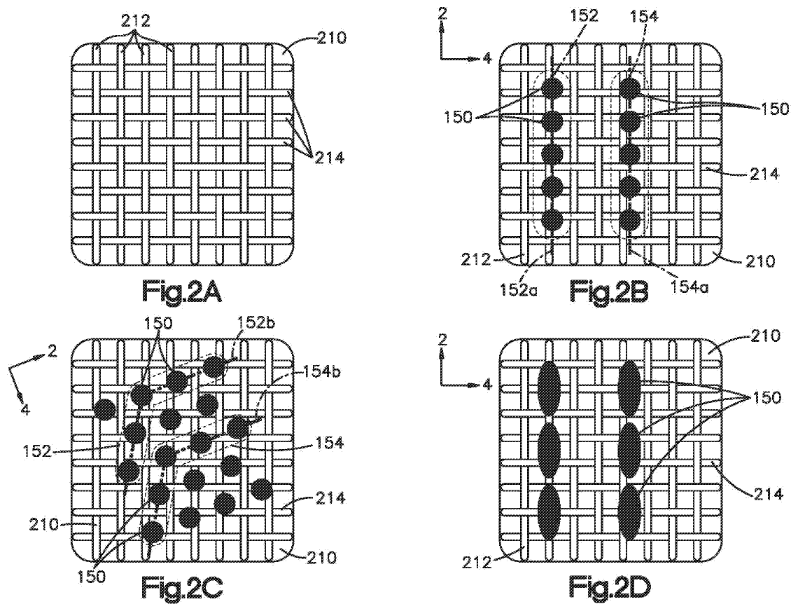

Turning now to FIGS. 2A-D, an example substrate in the form of a first fabric portion 210 can be seen. As depicted, in some examples, the first fabric portion 210 may include longitudinal threads or fibers 212. The first fabric portion 210 may further include transverse threads or fibers 214. The transverse fibers 214 of the first fabric portion 210 may be angularly offset from the longitudinal fibers 212 of the first fabric portion 210 so as to be non-parallel with the longitudinal fibers 212. In one example, the transverse fibers 214 of the first fabric portion 210 may be substantially perpendicular to the longitudinal fibers 212 of the first fabric portion 210. The first fabric portion 210 may generally be of any suitable size, shape, and/or material to suit a particular application. By way of non-limiting example, the first fabric portion 210 may have a thread or fiber count of from about 300 to about 800 per inch.

As depicted in FIGS. 2B-D, a plurality of adhesive formations 150 (e.g., spots) may be dispensed or otherwise applied or disposed onto the first fabric portion 210. It is to be understood that FIGS. 2B-D are for illustrative purposes only. In this regard, although the adhesive formations 150 in FIGS. 2B-D are shown as being dispensed or otherwise applied or disposed onto the first fabric portion 210 such that each adhesive formation attaches to about one or two of the longitudinal fibers 212 or transverse fibers 214, it will be understood that, in practice, each adhesive formation may attach to multiple threads or fibers, including from about 5 to about 20 threads or fibers, such as from about 4 to about 10 threads or fibers in each direction. Put another way, in certain examples, individual ones of the plurality of adhesive formations 150 may attach to from about 4 to about 10 of the threads or fibers along the first direction 2 (e.g., the longitudinal fibers 212 in this example) and may further attach to from about 4 to about 10 of the threads or fibers along the second direction 4 (e.g., the transverse fibers 214 in this example). Individual ones of the plurality of adhesive formations 150 may generally attach to as few or as many of the longitudinal fibers 212 and/or the transverse fibers 214 as desired to suit a particular application. As will be appreciated by those skilled in the art, the number of longitudinal fibers 212 and/or transverse fibers 214 to which individual ones of the plurality of adhesive formations 150 may be attached is generally a product of the thread or fiber count and the size of the adhesive formations. By way of non-limiting example, the first fabric portion 210 may have a thread or fiber count of about 508 per inch and each of the plurality of adhesive formations 150 may have a have a dimension (e.g., a width or a diameter) of from about 0.4-0.8 mm, such that each of the plurality of adhesive formations 150 may attach to from about 5 to about 20 threads or fibers, such as from about 4 to about 10 threads or fibers in each of the first and second directions 2, 4.

The adhesive formations 150 may be in a liquified state prior to the first fabric portion 210 being bonded to another fabric portion or may be in a solidified state once the first fabric portion 210 is bonded to another fabric portion. The plurality of adhesive formations 150 may comprise at least two, at least three, at least four, at least five, at least six, at least seven, at least eight, or more than eight adhesive formations 150. Each of the plurality of adhesive formations 150 may generally be dispensed onto the first fabric portion 210 so as to be spaced apart from other ones of the plurality of adhesive formations 150. In certain examples, individual ones (e.g., two, three, four, or more) of the plurality of adhesive formations 150 may be spaced from one another along a first direction 2. In some such examples, individual ones (e.g., two, three, four, or more) of the plurality of adhesive formations 150 may also be spaced from one another along a second direction 4 different from the first direction 2. Thus, in some examples, individual ones of the plurality of adhesive formations 150 may be spaced from other adhesive formations 150 along two different directions, where the two different directions may be substantially parallel to one another, substantially perpendicular to one another, or otherwise angularly offset from one another (i.e., so as to be non-parallel).

The adhesive formations 150 may generally be dispensed or otherwise applied or disposed onto the first fabric portion 210 such that individual ones (e.g., two, three, four, or more) of the adhesive formations 150 are spaced apart from one another so as to define a gap therebetween. As depicted in the example illustrated in FIG. 2B, the adhesive formations 150 (e.g., spots) may be dispensed or otherwise applied or disposed onto the first fabric portion 210 such that individual ones (e.g., two, three, four, or more) of the adhesive formations 150 are spaced from one another along the first direction 2. The adhesive formations 150 may also be dispensed or otherwise applied or disposed onto the first fabric portion 210 such that individual ones (e.g., two, three, four, or more) of the adhesive formations 150 are spaced from one another along the second direction 4.

The adhesive formations 150 can be arranged in at least one row and at least one column. In some examples, the adhesive formations 150 can be arranged in a plurality of rows and a plurality of columns. FIG. 2B shows one example in which the adhesive formations 150 are arranged in a 2×5 grid, though other examples are not so limited. In particular, the adhesive formations 150 may be arranged in two columns (i.e., with the columns extending along the first direction 2 and spaced apart from one another along the second direction 4 substantially perpendicular to the first direction 2) and five rows (i.e., with the rows extending along the second direction 4 and spaced apart from one another along the first direction 2 substantially perpendicular to the second direction 4). Each adhesive formation 150 can define a circular or dot shape as shown in FIG. 2B, a square shape, a triangular shape, an oblong shape, or any other suitable shape. Each adhesive formation 150 can have a dimension (e.g., a length) along the first direction 2 that is substantially equal to a dimension (e.g., a width) along the second direction 4, although examples of the disclosure are not so limited as will be discussed below.

The adhesive formations 150 within each column may generally be spaced apart from one another so as to define gaps between adjacent ones of the adhesive formations 150 in the column. In this example, the adhesive formations 150 within each column are generally spaced apart from one another along the first direction 2. In this example, the first direction 2 may generally be aligned with the longitudinal fibers 212 of the first fabric portion 210. The adhesive formations 150 within each column may generally be aligned with the longitudinal fibers 212 of the first fabric portion 210, although other examples of the disclosure are not so limited. The adhesive formations 150 within each row may generally be spaced apart from one another so as to define gaps between adjacent ones of the adhesive formations 150 in the row. In this example, the adhesive formations 150 within each row are generally spaced apart from one another along the second direction 4 substantially perpendicular to the first direction 2. In this example, the second direction 4 may generally be aligned with the transverse fibers 214 of the first fabric portion 210. The adhesive formations 150 within each row may generally be aligned with the transverse fibers 214 of the first fabric portion 210, although other examples of the disclosure are not so limited.

As described above, in the example illustrated in FIG. 2B, the first direction 2 is aligned with the longitudinal fibers 212 of the first fabric portion 210. Dispensing or otherwise applying or disposing the adhesive formations 150 onto the first fabric portion 210 such that individual ones of the plurality of adhesive formations 150 are spaced from one another along the first direction 2 aligned with the longitudinal fibers 212 may assist in maximizing flexibility of the first fabric portion 210 parallel to the longitudinal fibers 212. This pattern may further provide unbonded fibers or threads between bond points (i.e., dispensed adhesive formations 150) the ability to move freely when the spacing between the adhesive formations 150 is larger than the weave. Similarly, in the example illustrated in FIG. 2B, the second direction 4 is aligned with the transverse fibers 214 of the first fabric portion 210. Dispensing or otherwise applying or disposing the adhesive formations 150 onto the first fabric portion 210 such that individual ones of the plurality of adhesive formations 150 are spaced from one another along the second direction 4 aligned with the transverse fibers 214 may assist in maximizing flexibility of the first fabric portion 210 parallel to the transverse fibers 214. This pattern may further provide unbonded fibers or threads between bond points (i.e., dispensed adhesive formations 150) the ability to move freely when the spacing between the adhesive formations 150 is larger than the weave.

As described herein, in examples, individual ones of the adhesive formations 150 may be spaced apart from one another (e.g., along the first direction 2 and/or along the second direction 4) so as to define a gap therebetween. In examples, gaps may be defined on the first fabric portion between adjacent ones of the adhesive formations 150. In examples in which the first fabric portion has longitudinal fibers and transverse fibers (e.g., refer to first fabric portion 210 having longitudinal fibers 212 and transverse fibers 214), one or more of the longitudinal fibers and/or one or more of the transverse fibers may extend through the gaps. In such examples, the gaps are generally unbonded gaps (i.e., devoid of any adhesive formations 150), such that the portions of the one or more of the longitudinal fibers and/or the one or more of the transverse fibers within the gap are likewise unbonded. Providing unbonded gaps may assist in maximizing flexibility of the first fabric portion 210 in the gaps, such as by generally permitting the unbonded longitudinal fibers and/or the unbonded transverse fibers the ability to move freely when the gap has a cross-sectional dimension that is larger than the weave.

In the example illustrated in FIG. 2B, the plurality of adhesive formations 150 may define sets of adhesive formations 150, where the adhesive formations 150 in each set are spaced from one another so as to define gap between the formations 150 in each set, and the sets of adhesive formations 150 are spaced from one another so as to define gaps between the sets. For example, the plurality of adhesive formations 150 may define a first set of adhesive formations 150 and a second set of adhesive formations 150. It will be understood that, as used herein, the term “set” is used in the mathematical sense. Thus, as used herein, a “set” can define a plurality of elements or can define a single element (e.g., a unit set or singleton) unless otherwise defined to have a plurality of elements. The adhesive formations 150 in each set can be arranged in a straight line as shown or can be arranged along a curved or bent path as discussed below.

In one example as shown in FIG. 2B, the adhesive formations 150 define a first set 152 of adhesive formations 150 is spaced apart from a second set 154 of adhesive formations 150 along the second direction 4. The individual adhesive formations 150 in each of the first and second sets 152, 154 of adhesive formations 150 are also spaced apart from one another along the first direction 2 substantially perpendicular to the second direction 4. As such, a gap is defined between individual ones one of the adhesive formations 150 in the first set 152 of adhesive formations and individual ones of the adhesive formations 150 in the second set 154 of adhesive formations along the second direction 4. The adhesive formations 150 can additionally or alternatively define sets of adhesive formations 150 that are spaced apart from one another along the second direction 4, along the first and second directions 2 and 4, and/or along a direction that is angularly offset from the first direction 2 and/or the second direction 4. In certain examples, the first set 152 of adhesive formations 150 may generally be arranged along a first path 152a. In the example illustrated in FIG. 2B, the first path 152a may generally be aligned with the first direction 2. Similarly, in certain examples, the second set 154 of adhesive formations 150 may generally be arranged along a second path 154a. In the example illustrated in FIG. 2B, the second path 154a may generally be aligned with the first direction 2. In the example illustrated in FIG. 2B, the first set 152 of adhesive formations 150 are arranged along the first path 152a and the second set 154 of adhesive formations 150 are arranged along the second path 154a with the first and second paths 152a, 154a neither intersecting nor overlapping. The first and second paths 152a, 154a may, in certain examples such as the example illustrated in FIG. 2B, be substantially parallel to one another, although other examples of the disclosure are not so limited. The paths 152a, 154a may be linear as shown in FIG. 2B or may alternatively be curved or bent.

As described above, the adhesive formations 150 may generally be dispensed or otherwise applied or disposed onto the first fabric portion 210 such that individual ones (e.g., two, three, four, or more) of the adhesive formations 150 are spaced apart from one another so as to define a gap therebetween. As depicted in the example illustrated in FIG. 2C, the adhesive formations 150 (e.g., spots) may be dispensed or otherwise applied or disposed onto the first fabric portion 210 such that individual ones (e.g., two, three, four, or more) of the adhesive formations 150 are spaced from one another along the first direction 2. The adhesive formations 150 may also be dispensed or otherwise applied or disposed onto the first fabric portion 210 such that individual ones (e.g., two, three, four, or more) of the adhesive formations 150 are spaced from one another along the second direction 4. As described above with respect to FIG. 2B, the adhesive formations 150 can be arranged in at least one row and at least one column, such as in a plurality of rows and a plurality of columns. FIG. 2C shows one example in which the adhesive formations 150 are arranged in five columns (i.e., with the columns extending along the first direction 2 and spaced apart from one another along the second direction 4 substantially perpendicular to the first direction 2). In this example, the columns may alternate between having four or three rows (i.e., with the rows extending along the second direction 4 and spaced apart from one another along the first direction 2 substantially perpendicular to the second direction 4). Each adhesive formation can define a circular or dot shape as shown in FIG. 2C, a square shape, a triangular shape, an oblong shape, or any other suitable shape. Each adhesive formation 150 can have a dimension (e.g., a length) along the first direction 2 that is substantially equal to a dimension (e.g., a width) along the second direction 4, although examples of the disclosure are not so limited as will be discussed below. The plurality of adhesive formations 150 may, in certain examples, be arranged in a plurality of rows and/or a plurality of columns, such as one, two, three, four, five, or more than five rows and/or columns.

The adhesive formations 150 within each column may generally be spaced apart from one another so as to define a gap therebetween. In this example, the adhesive formations 150 within each column are generally spaced apart from one another along the first direction 2. In this example, the first direction 2 may generally be angularly offset from each of the longitudinal fibers 212 and the transverse fibers 214 of the first fabric portion 210, although other examples of the disclosure are not so limited. By way of non-limiting example, the first direction 2 may be offset from each of the longitudinal fibers 212 and the transverse fibers 214 of the first fabric portion 210 by from about 30 degrees to about 60 degrees, including about 45 degrees. The adhesive formations 150 within each column may generally be spaced apart from one another so as to define a gap therebetween. In this example, the adhesive formations 150 within each row are generally spaced apart from one another along the second direction 4 substantially perpendicular to the first direction 2. In this example, the second direction 4 may generally be angularly offset from each of the longitudinal fibers 212 and the transverse fibers 214 of the first fabric portion 210, although other examples of the disclosure are not so limited. By way of non-limiting example, the first direction 2 may be offset from each of the longitudinal fibers 212 and the transverse fibers 214 of the first fabric portion 210 by from about 30 degrees to about 60 degrees, including about 45 degrees.

As described above, in the example illustrated in FIG. 2C, the first direction 2 is offset from the longitudinal fibers 212 and the transverse fibers 214 of the first fabric portion 210 (e.g., by about 45 degrees). Dispensing or otherwise applying or disposing the adhesive formations 150 onto the first fabric portion 210 such that individual ones of the plurality of adhesive formations 150 are spaced from one another along the first direction 2 offset from the longitudinal fibers 212 and the transverse fibers 214 (e.g., by 45 degrees) may assist in maximizing flexibility of the first fabric portion 210 at an angle (e.g., 45 degrees) relative to the longitudinal fibers 212 and the transverse fibers 214. When biased to the longitudinal fibers 212, this pattern may further allow for bonding every fiber or thread with longer regions between bond points (i.e., dispensed adhesive formations 150). Similarly, in the example illustrated in FIG. 2C, the second direction 4 is offset from the longitudinal fibers 212 and the transverse fibers 214 of the first fabric portion 210. Dispensing or otherwise applying or disposing the adhesive formations 150 onto the first fabric portion 210 such that individual ones of the plurality of adhesive formations 150 are spaced from one another along the second direction 4 offset from the longitudinal fibers 212 and the transverse fibers 214 (e.g., by 45 degrees) may assist in maximizing flexibility of the first fabric portion 210 at an angle (e.g., 45 degrees) relative to the longitudinal fibers 212 and the transverse fibers 214. When biased to the longitudinal fibers 212, this pattern may further allow for bonding every fiber or thread with longer regions between bond points (i.e., dispensed adhesive formations 150).

In the example illustrated in FIG. 2C, the plurality of adhesive formations 150 may include a first set 152 of adhesive formations 150 and a second set 154 of adhesive formations 150. The first set 152 of adhesive formations 150 may generally be spaced apart from the second set 154 of adhesive formations 150 so as to define a gap therebetween.

In the example illustrated in FIG. 2C, a first set 152 of adhesive formations 150 is shown that is spaced apart from a second set 154 of adhesive formations 150 along both the first and second directions 2, 4. The individual adhesive formations 150 in each of the first and second sets 152, 154 of adhesive formations 150 are also spaced apart from one another along the first and second directions 2, 4. As such, a gap is defined between individual ones one of the adhesive formations 150 in the first set 152 of adhesive formations and individual ones of the adhesive formations 150 in the second set 154 of adhesive formations along both the first and second directions 2, 4. In certain examples, the first set 152 of adhesive formations 150 may generally be arranged along a first path 152b. The first path 152b may generally be curved or bent. Similarly, in certain examples, the second set 154 of adhesive formations 150 may generally be arranged along a second path 154b. The second path 154b may generally be curved or bent. In the example illustrated in FIG. 2C, the first set 152 of adhesive formations 150 are arranged along the first path 152b and the second set 154 of adhesive formations 150 are arranged along the second path 154b with the first and second paths 152b, 154b neither intersecting nor overlapping. The first and second paths 152a, 154a may, in certain examples such as the example illustrated in FIG. 2C, be substantially parallel to one another, although other examples of the disclosure are not so limited. The paths 152b, 154b may be curved or bent as shown in FIG. 2C or may alternatively be linear.

As described above, in examples, the plurality of adhesive formations 150 may define sets or multiple pluralities of adhesive formations 150, and multiple sets or pluralities of adhesive formations 150 may be dispensed such that individual ones of one set or plurality of liquified adhesive spots are spaced apart from individual ones of another set or plurality of liquified adhesive spots. As also described above, individual ones of the adhesive formations 150 within a given set or plurality of adhesive formations can be spaced apart from one another so as to define a respective plurality of unbonded gaps between the set or plurality of liquified adhesive spots. In some such examples, individual ones of one set of plurality of the adhesive formations 150 may be are aligned with the unbonded gaps defined by another set or plurality of the adhesive formations 150. Put another way, in certain examples, the adhesive formations 150 within one set or plurality of adhesive formations may be aligned with the unbonded gaps defined by or between the adhesive formations 150 of another set or plurality of adhesive formations.

As depicted in the example illustrated in FIG. 2D, the adhesive formations 150 (e.g., spots) may be dispensed or otherwise applied or disposed onto the first fabric portion 210 such that individual ones (e.g., two, three, four, or more) of the adhesive formations 150 define an oblong shape, although other examples of the disclosure are not so limited. FIG. 2D shows one example in which individual ones (e.g., two, three, four, or more) of the adhesive formations 150 define an oblong shape. Each adhesive formation 150 can have a dimension (e.g., a length) along the first direction 2 that is greater than a dimension (e.g., a width) along the second direction 4, although examples of the disclosure are not so limited as was discussed above. In the example illustrated in FIG. 2D, the first direction 2 is aligned with the longitudinal fibers 212 of the first fabric portion 210, and the second direction 4 is aligned with the transverse fibers 214 of the first fabric portion 210. Dispensing or otherwise applying or disposing the adhesive formations 150 onto the first fabric portion 210 such that individual ones of the plurality of adhesive formations 150 define an oblong shape having a dimension (e.g., a length) along the first direction 2 that is greater than a dimension (e.g., a width) along the second direction 4 may provide preferential flexibility along the second direction 4 (e.g., along the transverse fibers 214) as compared to along the first direction 2 (e.g. along the longitudinal fibers 212), which may thereby better simulate thread stitching.

Although the examples illustrated in FIGS. 2A-D depict specific arrangements or patterns of the adhesive formations 150, it will be understood that the adhesive formations 150 (e.g., spots) may be dispensed or otherwise applied or disposed onto the first fabric portion 210 by any desired means and in any desired shape, arrangement, and/or pattern to suit a particular application and/or to impart desired characteristics or properties. For example, in certain non-depicted examples, the adhesive formations 150 (e.g., spots) may be dispensed or otherwise applied or disposed onto the first fabric portion 210 in a random and/or undefined arrangement or pattern.

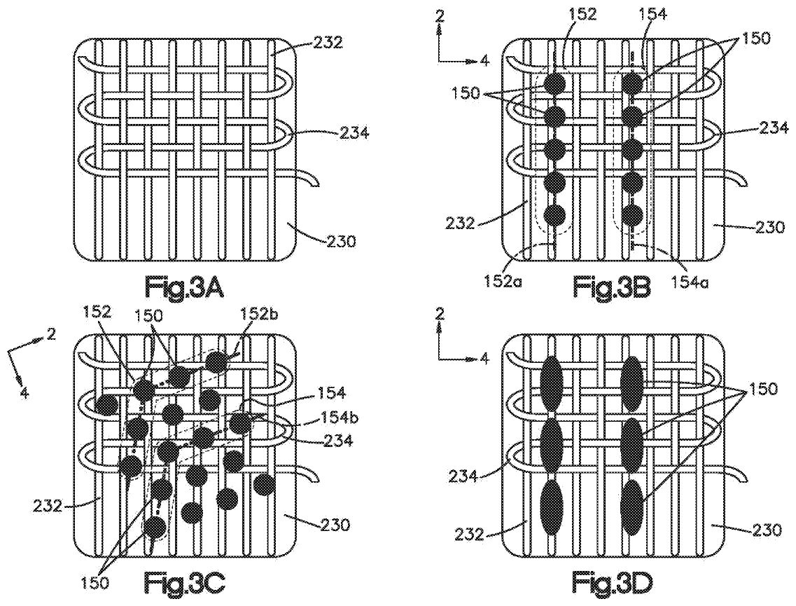

Turning now to FIGS. 3A-D, an example first fabric portion 230 in the form of a woven fabric can be seen. In FIGS. 3A-D, similar reference numerals are used to denote similar functions to those with respect to first fabric portion 210, and woven first fabric portion 230 may be substantially similar to first fabric portion 210, except as described below. That is, as will be appreciated by those skilled in the art, the foregoing disclosure with respect to adhesive formations 150 dispensed or otherwise applied or disposed onto the woven first fabric portion 210 may generally be equally applicable to adhesive formations 150 dispensed or otherwise applied or disposed onto the woven first fabric portion 230.

As depicted, in some examples, the woven first fabric portion 230 may include a warp 232 (e.g., warp fibers or threads). The first fabric portion 230 may further include a weft 234 (e.g., weft fibers or threads). The weft 234 of the first fabric portion 230 may be angularly offset from the warp 232 of the first fabric portion 230 so as to be non-parallel with the warp 232. In one example, the warp 232 of the woven first fabric portion 230 may be substantially perpendicular to the weft 234 of the woven first fabric portion 230. As depicted in FIGS. 3B-D, a plurality of adhesive formations 150 may be dispensed or otherwise applied or disposed onto the woven first fabric portion 230. In examples in which the first fabric portion is a woven fabric (e.g., woven first fabric portion 230), the warp 232 or warp fibers or threads can be considered to be the longitudinal fibers or the transverse fibers because the warp 232 or warp fibers or threads generally extend along the longitudinal direction or the transverse direction. Similarly, the weft 234 or weft fibers or threads can be considered to be the other of the longitudinal fibers or the transverse fibers because the weft 234 or weft fibers or threads generally extend along the longitudinal direction or the transverse direction.

The plurality of adhesive formations 150 dispensed or otherwise applied or disposed onto woven first fabric portion 230 illustrated in FIG. 3B are arranged and operate substantially similarly to the plurality of adhesive formations 150 illustrated in FIG. 2B and as described with respect to first fabric portion 210. That is, as depicted in the example illustrated in FIG. 3B, each of the adhesive formations 150 may be dispensed or otherwise applied or disposed onto the woven first fabric portion 230 so as to be spaced apart from other ones of the plurality of adhesive formations 150. In certain examples, individual ones (e.g., two, three, four, or more) of the plurality of adhesive formations 150 may be spaced from one another along the first direction 2 and/or along the second direction 4. In this example, the first direction 2 may generally be aligned with the warp 232 of the woven first fabric portion 230, and the second direction 4 may generally be aligned with the weft 234 of the woven first fabric portion 230, although other examples of the disclosure are not so limited. Similarly to as described above with respect to first fabric portion 210, dispensing or otherwise applying or disposing the adhesive formations 150 onto the woven first fabric portion 230 such that individual ones of the plurality of adhesive formations 150 are spaced from one another along the first direction 2 aligned with the warp 232 and/or such that individual ones of the plurality of adhesive formations 150 are spaced from one another along the second direction 4 aligned with the weft 234 may assist in maximizing flexibility of the woven first fabric portion 230 parallel to the warp 232 and/or the weft 234, respectively. This pattern may further provide unbonded fibers or threads between bond points (i.e., dispensed adhesive formations 150) the ability to move freely when the spacing between the adhesive formations 150 is larger than the weave.

The plurality of adhesive formations 150 dispensed or otherwise applied or disposed onto woven first fabric portion 230 illustrated in FIG. 3C are arranged and operate substantially similarly to the plurality of adhesive formations 150 illustrated in FIG. 2C and as described with respect to first fabric portion 210. That is, as depicted in the example illustrated in FIG. 3C, each of the adhesive formations 150 may be dispensed or otherwise applied or disposed onto the woven first fabric portion 230 so as to be spaced apart from other ones of the plurality of adhesive formations 150. In certain examples, individual ones (e.g., two, three, four, or more) of the plurality of adhesive formations 150 may be spaced from one another along the first direction 2 and/or along the second direction 4. In this example, the first direction 2 may generally be offset (e.g., by about 45 degrees) from the warp 232 and the weft 234 of the woven first fabric portion 230, and the second direction 4 may generally be offset (e.g., by about 45 degrees) from the warp 232 and the weft 234 of the woven first fabric portion 230, although other examples of the disclosure are not so limited. Similarly to as described above with respect to first fabric portion 210, dispensing or otherwise applying or disposing the adhesive formations 150 onto the woven first fabric portion 230 such that individual ones of the plurality of adhesive formations 150 are spaced from one another along the first direction 2 offset from the warp 232 and the weft 234 (e.g., by 45 degrees) and/or such that individual ones of the plurality of adhesive formations 150 are spaced from one another along the second direction 4 offset from the warp 232 and the weft 234 (e.g., by 45 degrees) may assist in maximizing flexibility of the woven first fabric portion 230 at an angle (e.g., 45 degrees) relative to the warp 232 and the weft 234. When biased to the warp 232, this pattern may further allow for bonding every fiber or thread with longer regions between bond points (i.e., dispensed adhesive formations 150).

The plurality of adhesive formations 150 dispensed or otherwise applied or disposed onto woven first fabric portion 230 illustrated in FIG. 3D are arranged and operate substantially similarly to the plurality of adhesive formations 150 illustrated in FIG. 2D and as described with respect to first fabric portion 210. That is, as depicted in the example illustrated in FIG. 3D, the adhesive formations 150 may be dispensed or otherwise applied or disposed onto the woven first fabric portion 230 such that individual ones (e.g., two, three, four, or more) of the adhesive formations 150 define an oblong shape, although other examples of the disclosure are not so limited. FIG. 3D shows one example in which individual ones (e.g., two, three, four, or more) of the adhesive formations 150 define an oblong shape. Each adhesive formation 150 can have a dimension (e.g., a length) along the first direction 2 that is greater than a dimension (e.g., a width) along the second direction 4, although examples of the disclosure are not so limited as was discussed above. In the example illustrated in FIG. 3D, the first direction 2 is aligned with the warp 232 of the woven first fabric portion 230, and the second direction 4 is aligned with the weft 234 of the woven first fabric portion 230. Similarly to as described above with respect to first fabric portion 210, dispensing or otherwise applying or disposing the adhesive formations 150 onto the woven first fabric portion 230 such that individual ones of the plurality of adhesive formations 150 define an oblong shape having a dimension (e.g., a length) along the first direction 2 that is greater than a dimension (e.g., a width) along the second direction 4 may provide preferential flexibility along the second direction 4 (e.g., along the weft 234) as compared to along the first direction 2 (e.g., along the warp 232), which may thereby better simulate thread stitching.

In examples in which the first fabric portion has a warp and a weft (e.g., refer to woven first fabric portion 230 having a warp 232 or warp fibers or threads and a weft 234 or weft fibers or threads), one or more of the warp fibers or threads and/or one or more of the weft fibers or threads may extend through the gaps. In such examples, the gaps are generally unbonded gaps (i.e., devoid of any adhesive formations 150), such that the portions of the one or more of the warp fibers or threads and/or the one or more of the weft fibers or threads within the gap are likewise unbonded. Providing unbonded gaps may assist in maximizing flexibility of the first fabric portion 230 in the gaps, such as by generally permitting the unbonded warp fibers or threads and/or the unbonded weft fibers or threads the ability to move freely when the gap has a cross-sectional dimension that is larger than the weave.

As described above, although the examples illustrated in FIGS. 3A-D depict specific arrangements or patterns of the adhesive formations 150, it will be understood that the adhesive formations 150 may be dispensed or otherwise applied or disposed onto the woven first fabric portion 230 by any desired means and in any desired shape, arrangement, and/or pattern to suit a particular application and/or to impart desired characteristics or properties. For example, in certain non-depicted examples, the adhesive formations 150 may be dispensed or otherwise applied or disposed onto the woven first fabric portion 230 in a random and/or undefined arrangement or pattern.

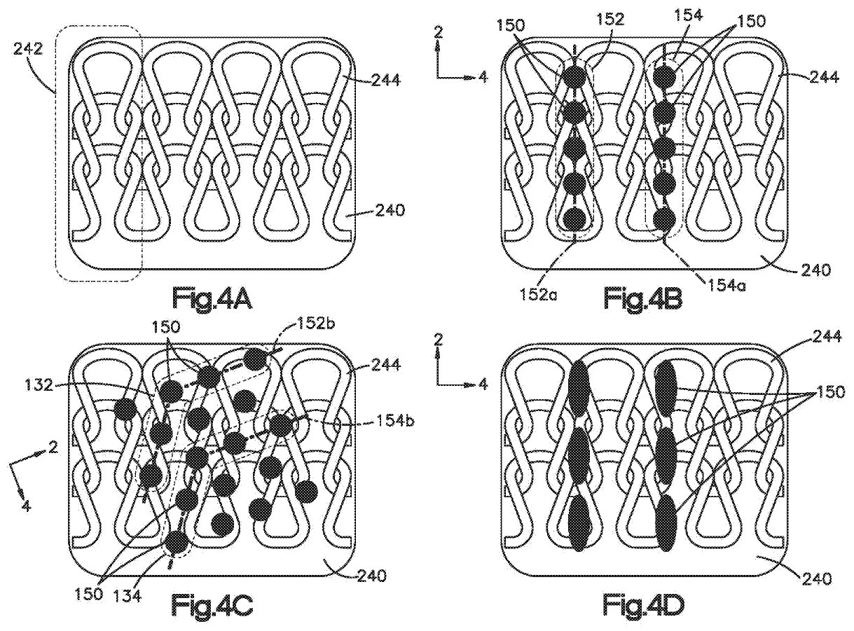

Turning now to FIGS. 4A-D, an example first fabric portion 240 in the form of a knitted fabric can be seen. In FIGS. 4A-D, similar reference numerals are used to denote similar functions to those with respect to first fabric portion 210, and knitted first fabric portion 240 may be substantially similar to first fabric portion 210, except as described below. That is, as will be appreciated by those skilled in the art, the foregoing disclosure with respect to adhesive formations 150 dispensed or otherwise applied or disposed onto the woven first fabric portion 210 may generally be equally applicable to adhesive formations 150 dispensed or otherwise applied or disposed onto the woven first fabric portion 240.

As depicted, in some examples, the knitted first fabric portion 240 may include courses 242. The first fabric portion 240 may further includes wales 244. The wales 244 of the first fabric portion 240 may be angularly offset from the courses 242 of the first fabric portion 240 so as to be non-parallel with the courses 242. In one example, the courses 242 of the knitted first fabric portion 240 may be substantially perpendicular to the wales 244 of the knitted first fabric portion 240. As depicted in FIGS. 4B-D, a plurality of adhesive formations 150 may be dispensed or otherwise applied or disposed onto the knitted first fabric portion 240. In examples in which the first fabric portion is a knitted fabric (e.g., knitted first fabric portion 240), the courses 242 or course fibers or threads can be considered to be the longitudinal fibers or the transverse fibers because the courses 242 or course fibers or threads generally extend along the longitudinal direction or the transverse direction. Similarly, the wales 244 or wale fibers or threads can be considered to be the other of the longitudinal fibers or the transverse fibers because the wales 244 or wale fibers or threads generally extend along the longitudinal direction or the transverse direction.

The plurality of adhesive formations 150 dispensed or otherwise applied or disposed onto knitted first fabric portion 240 illustrated in FIG. 4B are arranged and operate substantially similarly to the plurality of adhesive formations 150 illustrated in FIG. 2B and as described with respect to first fabric portion 210. That is, as depicted in the example illustrated in FIG. 4B, the adhesive formations 150 may be dispensed or otherwise applied or disposed onto the knitted first fabric portion 240 so as to be spaced apart from other ones of the plurality of adhesive formations 150. In certain examples, individual ones (e.g., two, three, four, or more) of the plurality of adhesive formations 150 may be spaced from one another along the first direction 2 and/or along the second direction 4. In this example, the first direction 2 may generally be aligned with the courses 242 of the knitted first fabric portion 240, and the second direction 4 may generally be aligned with the wales 244 of the knitted first fabric portion 240, although other examples of the disclosure are not so limited. Similarly to as described above with respect to first fabric portion 210, dispensing or otherwise applying or disposing the adhesive formations 150 onto the knitted first fabric portion 240 such that individual ones of the plurality of adhesive formations 150 are spaced from one another along the first direction 2 aligned with the courses 242 and/or such that individual ones of the plurality of adhesive formations 150 are spaced from one another along the second direction 4 aligned with the wales 244 may assist in maximizing flexibility of the woven first fabric portion 230 parallel to the courses 242 and/or the wales 244, respectively. This pattern may further provide unbonded fibers or threads between bond points (i.e., dispensed adhesive formations 150) the ability to move freely when the spacing between the adhesive formations 150 is larger than the weave.

The plurality of adhesive formations 150 dispensed or otherwise applied or disposed onto knitted first fabric portion 240 illustrated in FIG. 4C are arranged and operate substantially similarly to the plurality of adhesive formations 150 illustrated in FIG. 2C and as described with respect to first fabric portion 210. That is, as depicted in the example illustrated in FIG. 4C, the adhesive formations 150 may be dispensed or otherwise applied or disposed onto the knitted first fabric portion 240 so as to be spaced apart from other ones of the plurality of adhesive formations 150. In certain examples, individual ones (e.g., two, three, four, or more) of the plurality of adhesive formations 150 may be spaced from one another along the first direction 2 and/or along the second direction 4. In this example, the first direction 2 may generally be offset (e.g., by about 45 degrees) from the courses 242 and the wales 244 of the knitted first fabric portion 240, and the second direction 4 may generally be offset (e.g., by about 45 degrees) from the courses 242 and the wales 244 of the knitted first fabric portion 240, although other examples of the disclosure are not so limited. Similarly to as described above with respect to first fabric portion 210, dispensing or otherwise applying or disposing the adhesive formations 150 onto the knitted first fabric portion 240 such that individual ones of the plurality of adhesive formations 150 are spaced from one another along the first direction 2 offset from the courses 242 and the wales 244 (e.g., by 45 degrees) and/or such that individual ones of the plurality of adhesive formations 150 are spaced from one another along the second direction 4 offset from the courses 242 and the wales 244 (e.g., by 45 degrees) may assist in maximizing flexibility of the knitted first fabric portion 240 at an angle (e.g., 45 degrees) relative to the courses 242 and the wales 244. When biased to the courses 242, this pattern may further allow for bonding every fiber or thread with longer regions between bond points (i.e., dispensed adhesive formations 150).

The plurality of adhesive formations 150 dispensed or otherwise applied or disposed onto knitted first fabric portion 240 illustrated in FIG. 4D are arranged and operate substantially similarly to the plurality of adhesive formations 150 illustrated in FIG. 2D and as described with respect to first fabric portion 210. That is, as depicted in the example illustrated in FIG. 4D, the adhesive formations 150 may be dispensed or otherwise applied or disposed onto the knitted first fabric portion 240 such that individual ones (e.g., two, three, four, or more) of the adhesive formations 150 define an oblong shape, although other examples of the disclosure are not so limited. FIG. 4D shows one example in which individual ones (e.g., two, three, four, or more) of the adhesive formations 150 define an oblong shape. Each adhesive formation 150 can have a dimension (e.g., a length) along the first direction 2 that is greater than a dimension (e.g., a width) along the second direction 4, although examples of the disclosure are not so limited as was discussed above. In the example illustrated in FIG. 4D, the first direction 2 is aligned with the courses 242 of the knitted first fabric portion 240 and the second direction 4 is aligned with the wales 244 of the knitted first fabric portion 240. Similarly to as described above with respect to first fabric portion 210, dispensing or otherwise applying or disposing the adhesive formations 150 onto the knitted first fabric portion 240 such that individual ones of the plurality of adhesive formations 150 define an oblong shape having a dimension (e.g., a length) along the first direction 2 that is greater than a dimension (e.g., a width) along the second direction 4 may provide preferential flexibility along the second direction 4 (e.g., along the wales 244) as compared to along the first direction 2 (e.g., along the courses 242), which may thereby better simulate thread stitching.

In examples in which the first fabric portion has courses and wales (e.g., refer to knitted first fabric portion 240 having courses 232 or course fibers or threads and wales 242 or wale fibers or threads), one or more of the courses and/or one or more of the wales may extend through the gaps. In such examples, the gaps are generally unbonded gaps (i.e., devoid of any adhesive formations 150), such that the portions of the one or more of the courses and/or the one or more wales within the gap are likewise unbonded. Providing unbonded gaps may assist in maximizing flexibility of the first fabric portion 240 in the gaps, such as by generally permitting the unbonded courses and/or the unbonded wales the ability to move freely when the gap has a cross-sectional dimension that is larger than the weave.

As described above, although the examples illustrated in FIGS. 4A-D depict specific arrangements or patterns of the adhesive formations 150, it will be understood that the adhesive formations 150 may be dispensed or otherwise applied or disposed onto the knitted first fabric portion 240 by any desired means and in any desired shape, arrangement, and/or pattern to suit a particular application and/or to impart desired characteristics or properties. For example, in certain non-depicted examples, the adhesive formations 150 may be dispensed or otherwise applied or disposed onto the knitted first fabric portion 240 in a random and/or undefined arrangement or pattern.

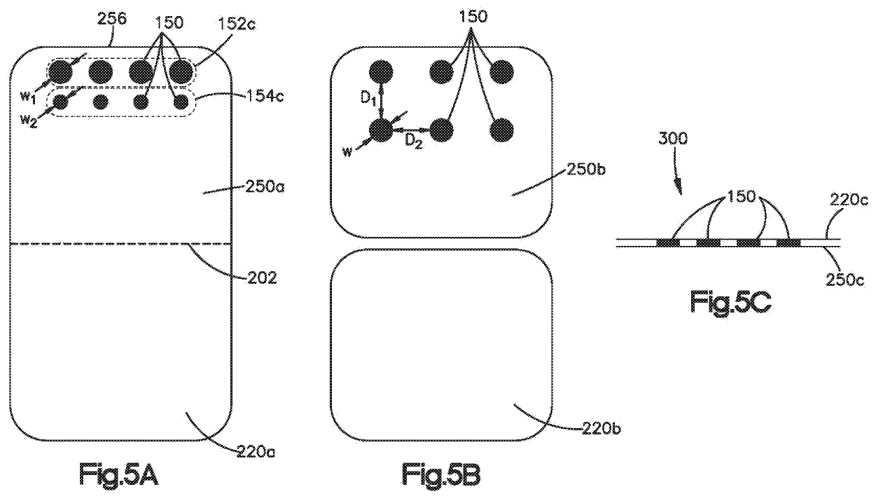

Turning now to FIG. 5A, another example first fabric portion 250a is illustrated. As depicted in FIG. 5A, a plurality of liquified adhesive formations 150 (e.g., spots) may be dispensed or otherwise applied or disposed onto the first fabric portion 250a. In the example illustrated in FIG. 5A, the plurality of adhesive formations 150 may include a first set 152 of adhesive formations 150 and a second set 154c of adhesive formations 150. The first set 152c of adhesive formations 150 may generally be positioned proximate an edge 256 of the first fabric portion 250a. The first set 152c of adhesive formations 150 may also generally be spaced apart from the second set 154c of adhesive formations 150 along the first direction 2. The second set 154c of adhesive formations 150 may, as depicted in the example illustrated in FIG. 5A, be positioned inwardly of the first set 152c of adhesive formations 150 with respect to the edge 256 of the first fabric portion 250a (i.e., such that the first set 152c of adhesive formations 150 is positioned closer to the edge 256 of the first fabric portion 250a than the second set 154c of adhesive formations 150).

In this example, each adhesive formation 150 of the first set 152c of adhesive formations 150 has a dimension W₁ that is greater than a dimension W₂ of each adhesive formation 150 of the second set 154c of adhesive formations 150. Dispensing or otherwise applying or disposing the adhesive formations 150 onto the first fabric portion 250a such that the second set 154c of adhesive formations 150 is positioned inwardly of the first set 152c of adhesive formations 150 with respect to the edge 256 of the first fabric portion 250a and each adhesive formation 150 of the first set 152c of adhesive formations 150 has a dimension W₁ that is greater than a dimension W₂ of each adhesive formation 150 of the second set 154c of adhesive formations 150 may assist in optimizing adhesive utilization (e.g., using the minimal amount of adhesive necessary to achieve a desired bond strength and feel) near the edge 256 of the first fabric portion 250a where tears in the first fabric portion 250a may otherwise originate.

In examples, portions of fabric may be bonded to one another (e.g., to create or form an article). For instance, a second fabric portion may be applied to the plurality of adhesive formations 150 dispensed onto a first fabric portion so as to adhere the second fabric portion to the first fabric portion.

In the example illustrated in FIG. 5A, the first fabric portion 250a may be directly connected to a second fabric portion 220a. Put another way, in this example, the first fabric portion 250a and the second fabric portion 220a may both be part of an integrated piece of fabric (i.e., with the first and second fabric portions being integral to one another). In such examples, the single integrated piece of fabric (e.g., defined by first and second fabric portions 250a, 220a) may be folded such that second fabric portion 220a is applied to the plurality of liquified formations dispensed or otherwise applied or disposed onto the first fabric portion 250a, thereby adhering the first and second fabric portions 250a, 220a to one another.

Turning now to FIG. 5B, another example first fabric portion 250b is illustrated. As depicted in FIG. 5B, a plurality of liquified adhesive formations 150 (e.g., spots) may be dispensed or otherwise applied or disposed onto the first fabric portion 250b. In the example illustrated in FIG. 5B, individual ones of the plurality of adhesive formations 150 may be spaced apart from one another along a first direction by a distance D₁ and/or spaced apart from one another along a second direction by a distance D₂. The distance(s) D₁, D₂ between individual ones of the plurality of adhesive formations 150 may in certain examples, such as the example illustrated in FIG. 5B, may be equal to or greater than a dimension (e.g., a width W) of each of the plurality of adhesive formations 150.

In the example illustrated in FIG. 5B, the first fabric portion 250b may be detached from a second fabric portion 220b. Put another way, in this example, the first fabric portion 250b and the second fabric portion 220b may be separate and distinct pieces of fabric. In such examples, the second fabric portion 220b may be applied to the plurality of liquified formations dispensed or otherwise applied or disposed onto the first fabric portion 250b, thereby adhering the first and second fabric portions 250b, 220b to one another.

As described above, in some examples, two or more portions of fabric may be bonded and/or adhered to one another to create or form an article 300. By bonding and/or adhering multiple portions of fabric to one another, an article 300 (e.g., a garment) may be created or formed with or without stitching.

FIG. 5C illustrates an example article (e.g., garment) created by bonding portions of fabric to one another. In FIG. 5C, article 300 includes a first fabric portion 250c onto which a plurality of adhesive formations 150 have been dispensed or otherwise applied or disposed such that the plurality of adhesive formations 150 are spaced apart from one another. Article 300 also includes a second fabric portion 220c that has been adhered to the first fabric portion 250c by being applied to the plurality of adhesive formations 150 dispensed or otherwise applied or disposed onto the first fabric portion 250c. In the example illustrated in FIG. 5C, the second fabric portion 220c is positioned above or over the first fabric portion 250c (e.g., by moving or folding the second fabric portion 220c downwardly toward the first fabric portion 250c and against the plurality of liquefied adhesive formations 150 thereon). However, it will be understood that the second fabric portion 220c could alternatively be positioned below or under the first fabric portion 250c and adhered thereto by moving or folding the second fabric portion 220c upwardly toward the first fabric portion 250c and against the plurality of liquefied adhesive formations 150 thereon. Further yet, it will be understood that the second fabric portion 220c could alternatively be positioned to one side of the first fabric portion 250c and adhered thereto by moving or folding the second fabric portion 220c toward the first fabric portion 250c and against the plurality of liquefied adhesive formations 150 thereon.

Depending upon certain characteristics of the adhesive formations, it may be desirable to apply the second fabric portion to the first fabric portion as quickly as possible so as to avoid the undesirable situation in which the adhesive formations begin to lose their adhesive properties. For instance, by way of non-limiting example, the second fabric portion may be applied to the plurality of liquified adhesive formations dispensed onto the first fabric portion within about 20 seconds of applying a first one of the plurality of liquified adhesive formations onto the first fabric portion, such as within about 10 seconds, such as within about 5 seconds.

As described above, it will be understood that the adhesive formations 150 may be dispensed or otherwise applied or disposed by any desired means and in any desired shape, arrangement, and/or pattern to suit a particular application and/or to impart desired characteristics or properties as described herein. Similarly, individual ones of the plurality of adhesive formations may be spaced apart from one another by any desired amount to suit a particular application and/or to impart desired characteristics or properties as described herein. For instance, by way of non-limiting example, each of the plurality of adhesive formations may have a dimension (e.g., a width or a diameter) of from about 0.2 mm to about 1.0 mm, including from about 0.4 mm to about 0.8 mm, such as about 0.6 mm. By way of further non-limiting example, individual ones of the plurality of the adhesive formations may be spaced apart from adjacent ones of the adhesive formations by from about 0.2 mm to about 1.0 mm, including from about 0.4 mm to about 0.8 mm, such as about 0.6 mm. By way of further non-limiting example, each of the plurality of adhesive formations may have a bond strength per gram of at least 50 lbf/g, such as at least 100 lbf/g, such as at least 150 lbf/g. By way of further non-limiting example, each of the plurality of adhesive formations may have a bonding strength of from about 1,000N to about 1,400N, including from about 1,140N to about 1,200N. By way of further non-limiting example, each of the plurality of adhesive formations may have a mass of less than 0.10 grams, such as at least 0.08 grams, such as less than 0.05 grams, including about 0.151 mg. Generally, each one of the plurality of adhesive formations may be separate and distinct from other ones of the plurality of adhesive formations and do not contact one another.

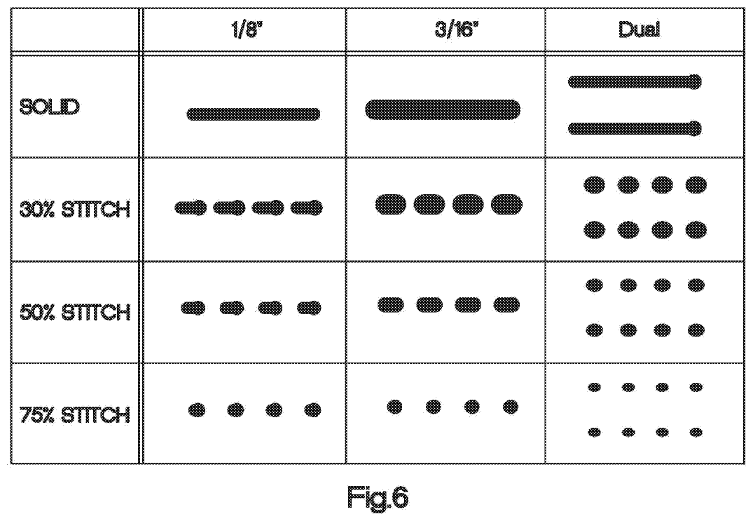

Turning to FIG. 6, a variety of different adhesive formations and patterns dispensed or otherwise applied or disposed onto a random-fibrous paper substrate are illustrated. As depicted in the last three rows, the adhesive formations may be dispensed or otherwise applied or disposed in the form of spots such that individual ones (e.g., one, two, three, four, or more) of the adhesive spots are spaced apart from one another along a line or path. Each line or path may have a first dimension (e.g., a width) and a second dimension (e.g., a length). Within each line or path, the adhesive spots may require the use of at least 30% less adhesive as compared to a solid line having the same dimensions (e.g., the same length and width). In some such examples, within each line or path, the adhesive spots may require the use of at least 35%, 40%, 45%, 50%, 55%, 60%, 65%, 70%, 75%, or 80% less adhesive as compared to a solid line having the same dimensions (e.g., the same length and width).

With continued reference to FIG. 6, in the first row, the terms ⅛″ and 3/16″ refer to a dimension (e.g., a width) of the single, solid adhesive formation (e.g., in the form of a bead or line, refer to the second row of FIG. 6) or, in the case of a plurality of adhesive formations in the form of spots (refer to the third, fourth, and fifth rows of FIG. 6) to a dimension (e.g., a width) of individual ones of the plurality of adhesive spots. Additionally, in the first row, the term “Dual” refers to two substantially parallel lines or beads or two parallel sets of adhesive formations in the form of spots. In the first column, the term “solid” refers to a single, solitary adhesive formation or line (e.g., a continuous bead of adhesive) and the term “stitch” refers to the relative amount of adhesive applied in each non-continuous adhesive formation (e.g., a plurality of adhesive formations in the form of spots). For instance, as compared to the “solid” adhesive formation or line (refer to the second row of FIG. 6) in each respective column, individual ones of the plurality of adhesive formations having a 30% stitch (refer to the third row in FIG. 6) use 30% less adhesive, individual ones of the plurality of adhesive formations having a 50% stitch (refer to the fourth row in FIG. 6) use 50% less adhesive, and individual ones of the plurality of adhesive formations having a 75% stitch (refer to the fifth row in FIG. 6) use 75% less adhesive. Despite that the adhesive formations in the form of spots (refer to the last three rows in FIG. 6) use significantly less adhesive than a continuously solid bead of adhesive (refer to the second row in FIG. 6), it has been found that the adhesive formations in the form of spots achieve the same or a greater bond strength and desired feel of the bond site as compared with the continuously solid bead of adhesive having the same dimensions. Advantageously, this may provide for new adhesive formations that are quicker to apply and that are the same or better than prior adhesive formations while requiring the use of significantly less adhesive.

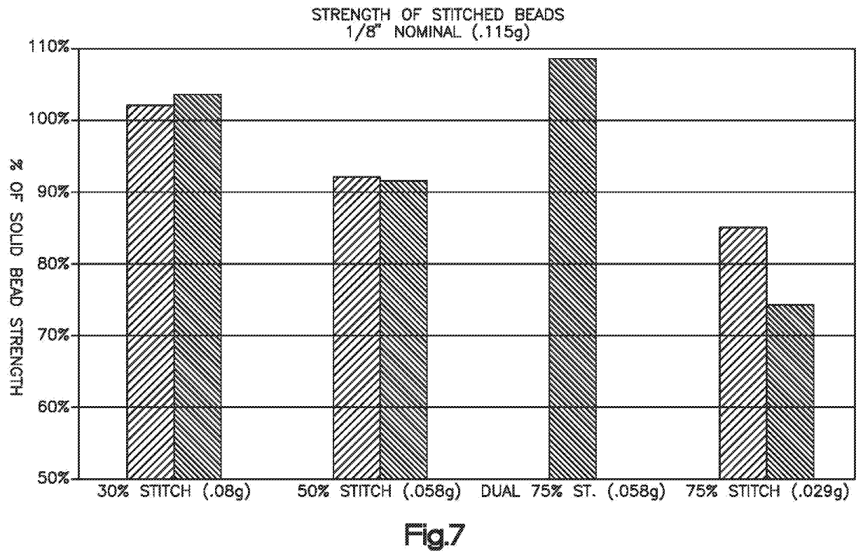

Referring now to FIG. 7, certain adhesive formations are plotted on the bar graph illustrated in FIG. 7 based on testing of a Henkel Technomelt Cool 250A, 250F adhesive on a random-fibrous paper substrate. Generally, FIG. 7 illustrates stitching performance as compared to a single, solid adhesive formation (e.g., in the form of a bead or line). In FIG. 7, the y-axis represents the percentage of solid bead strength and ranges from 50% to 110%. Along the x-axis are four adhesive formations. The leftmost pair of bars represent a plurality of adhesive formations having a 30% stitch and with individual ones of the plurality of adhesive formations have a mass of about 0.08 g. The second pair of bars represent a plurality of adhesive formations having a 50% stitch and with individual ones of the plurality of adhesive formations have a mass of about 0.058 g. The third pair of bars represent a plurality of adhesive formations having a dual 75% stitch and with individual ones of the plurality of adhesive formations have a mass of about 0.058 g. Within each pair of bars, individual ones of the bars represent different batches of the same random-fibrous paper substrate were tested. The rightmost pair of bars represent a plurality of adhesive formations having a 75% stitch and with individual ones of the plurality of adhesive formations have a mass of about 0.029 g.

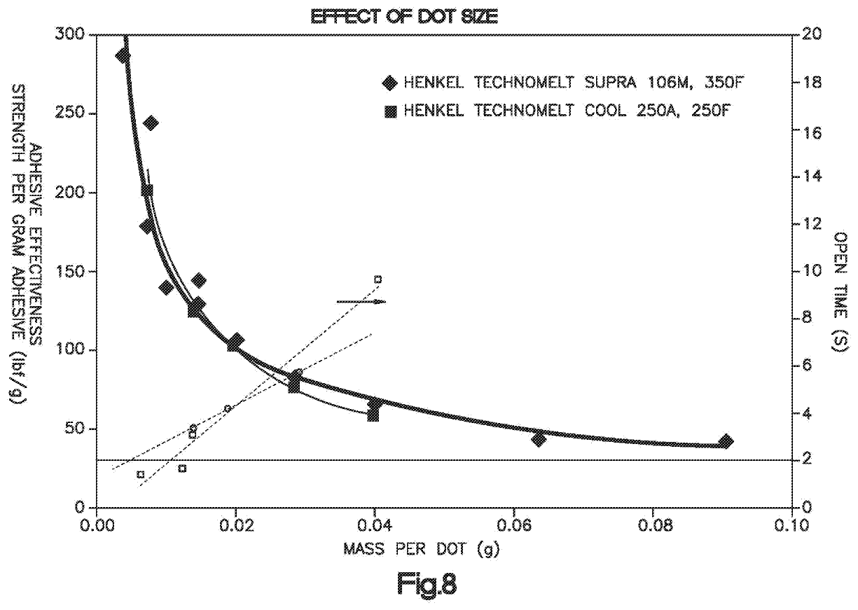

Referring now to FIG. 8, certain adhesive formations are plotted on the bar graph illustrated in FIG. 8 based on testing of a Henkel Technomelt Supra 106M, 350F adhesive (line with diamond-shaped points) and a Henkel Technomelt Cool 250A, 250F adhesive (line with square-shaped points) on a random-fibrous paper substrate. Generally, FIG. 8 illustrates the effect of dot size on adhesive effectiveness. In FIG. 8, the left-side y-axis represents the adhesive effectiveness based on strength per gram in lbf/g. The right-side y-axis represents the open time(s) in seconds. The open time(s) refers to the amount of time after an adhesive formation is dispensed before the adhesive formation loses its adhesive properties and is represented by dashed lines in FIG. 8. The x-axis represents the mass per adhesive formation (g).

As will be understood with reference to FIG. 7 and FIG. 8, it has been found that by breaking individual ones of the plurality of adhesive formations into smaller formations (e.g., dots), stitching may result in equivalent strength with less adhesive needing to be applied. Importantly, it has been found that equivalent strength to solid adhesive formations can be achieved by adhesive formations having as high as a 75% stitch. As will be further understood, there is a limitation on the size of individual ones of the adhesive formations depending upon how quickly the bond can occur (i.e., a balance between the open time and the dot size).

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Unless explicitly stated otherwise, each numerical value and range should be interpreted as being approximate as if the word “about,” “approximately,” or “substantially” preceded the value or range. The terms “about” and “approximately” can be understood as describing a range that is within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

While certain examples have been described, these examples have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and articles described herein may be embodied in a variety of other forms; furthermore, various omissions, substitutions, and changes in the form of the methods and articles described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various examples of the present invention.

Although the elements in the following method claims are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

1. A method of bonding portions of fabric to one another, the method comprising:
dispensing a plurality of liquified adhesive spots onto a first fabric portion having longitudinal fibers and transverse fibers so that individual ones of the plurality of liquified adhesive spots are spaced apart from one another so as to define a plurality of unbonded gaps between the adhesive spots, wherein (i) a portion of at least one longitudinal fiber, (ii) a portion of at least one transverse fiber, or (iii) a portion of at least one longitudinal fiber and a portion of at least one transverse fiber extends through each of the unbonded gaps and is unbonded by liquid adhesive; and
applying a second fabric portion to the plurality of liquified adhesive spots dispensed onto the first fabric portion so as to adhere the second fabric portion to the first fabric portion.

2. The method of claim 1, wherein the dispensing step comprises dispensing the plurality of liquified adhesive spots such that individual ones of the plurality of liquified adhesive spots are spaced from one another along a first direction.

3. The method of claim 2, wherein the dispensing step comprises dispensing the plurality of liquified adhesive spots such that individual ones of the plurality of liquified adhesive spots are spaced apart from one another along a second direction, different from the first direction.

4. The method of claim 3, wherein the first direction and the second direction are angularly offset from one another so as to be non-parallel.

5. The method of claim 4, wherein the first direction is substantially perpendicular to the second direction.

6. The method of claim 2, wherein the dispensing step comprises dispensing the plurality of liquified adhesive spots along the first direction, where the first direction is aligned with either the longitudinal fibers or the transverse fibers.

7. The method of claim 6, wherein:
the dispensing step comprises dispensing the plurality of liquified adhesive spots such that individual ones of the plurality of liquified adhesive spots are spaced apart from one another along a second direction, different from the first direction;
the first direction is aligned with the longitudinal fibers; and
the second direction is aligned with the transverse fibers.

8. The method of claim 2, wherein the dispensing step comprises dispensing the plurality of liquified adhesive spots along the first direction, where the first direction is offset from each of the longitudinal fibers and the transverse fibers by about 45°.

9. The method of claim 8, wherein:
the dispensing step comprises dispensing the plurality of liquified adhesive spots such that individual ones of the plurality of liquified adhesive spots are spaced apart from one another along a second direction, different from the first direction; and
the second direction is offset from each of the longitudinal fibers and the transverse fibers by about 45°.

10. The method of claim 2, wherein the first fabric portion is a woven fabric having a warp and a weft, the warp including one of the longitudinal fibers and the transverse fibers and the weft including the other of the longitudinal fibers and the transverse fibers, and wherein the dispensing step comprises dispensing the plurality of liquified adhesive spots along the first direction, where the first direction is aligned with either the warp or the weft.

11. The method of claim 2, wherein the first fabric portion is a woven fabric having a warp and a weft, the warp including one of the longitudinal fibers and wherein the dispensing step comprises dispensing the plurality of liquified adhesive spots along the first direction, where the first direction is offset from each of the warp and the weft by about 45°.

12. The method of claim 2, wherein the first fabric portion is a knitted fabric having courses and wales, the courses including one of the longitudinal fibers and the transverse fibers and the wales including the other of the longitudinal fibers and the transverse fibers, and wherein the dispensing step comprises dispensing the plurality of liquified adhesive spots along the first direction, where the first direction is aligned with either the courses or the wales.

13. The method of claim 2, wherein the first fabric portion is a knitted fabric having courses and wales, the courses including one of the longitudinal fibers and the transverse fibers and the wales including the other of the longitudinal fibers and the transverse fibers, and the dispensing step comprises dispensing the plurality of liquified adhesive spots along the first direction, where the first direction is offset from each of the courses and the wales by about 45°.

14. The method of claim 1, wherein the dispensing step comprises dispensing the plurality of liquified adhesive spots such that a first set of the plurality of liquified adhesive spots are arranged along a first path and a second set of the plurality of liquified adhesive spots are arranged along a second path, the first and second paths neither intersecting nor overlapping.

15. The method of claim 14, wherein the first and second paths are substantially parallel to one another.

16. The method of claim 1, wherein the dispensing step comprises dispensing the plurality of liquified adhesive spots such that individual ones of the plurality of liquified adhesive spots define an oblong shape.

17. The method of claim 1, wherein the applying step comprises applying the second fabric portion to the plurality of liquified adhesive spots dispensed onto the first fabric portion within about 20 seconds of dispensing a first one of the plurality of liquified adhesive spots onto the first fabric portion.

18. The method of claim 1, wherein each of the plurality of liquified adhesive spots has a dimension of from about 0.4 mm to about 0.8 mm.

19. The method of claim 1, wherein individual ones of the plurality of liquified adhesive spots are spaced apart from adjacent ones of the plurality of liquified adhesive spots by from about 0.2 mm to about 1.0 mm.

20. The method of claim 1, wherein each of the plurality of adhesive spots has a bond strength per gram of at least 50 lbf/g.

21. The method of claim 1, wherein each of the plurality of adhesive spots has a mass of less than 0.10 grams.

22. The method of claim 1, wherein each one of the plurality of adhesive spots is separate and distinct from other ones of the plurality of adhesive spots and do not contact one another.

23. The method of claim 1, wherein:
the plurality of liquified adhesive spots includes a first set of liquified adhesive spots and a second set of liquified adhesive spots;
the first set of liquified adhesive spots is positioned proximate an edge of the first fabric portion;
the second set of liquified adhesive spots is positioned inwardly of the first set of liquified adhesive spots with respect to the edge of the first fabric portion; and
each liquified adhesive spot of the first set of liquified adhesive spots has a dimension that is greater than a dimension of each liquified adhesive spot of the second set of liquified adhesive spots.

24. The method of claim 1, wherein the dispensing step comprises dispensing the plurality of liquified adhesive spots onto the first fabric portion along a length so that individual ones of the plurality of liquified adhesive spots are spaced from one another along a dispensed line requiring at least 30% less adhesive as compared to a solid line having the same length.

25. A method of bonding portions of fabric to one another, the method comprising:
dispensing a plurality of liquified adhesive spots onto a first fabric portion along a length so that individual ones of the plurality of liquified adhesive spots are spaced from one another along a dispensed line requiring at least 30% less adhesive as compared to a solid line having the same length; and
applying a second fabric portion to the plurality of liquified adhesive spots dispensed onto the first fabric portion so as to adhere the second fabric portion to the first fabric portion.

26. The method of claim 25, wherein the dispensed line requires at least 50% less adhesive as compared to a solid line having the same length.

27. The method of claim 25, wherein the dispensed line requires at least 70% less adhesive as compared to a solid line having the same length.

28. The method of claim 25, wherein each of the plurality of liquified adhesive spots has a dimension of from about 0.4 mm to about 0.8 mm.

29. The method of claim 25, wherein individual ones of the plurality of liquified adhesive spots are spaced apart from adjacent ones of the plurality of liquified adhesive spots by from about 0.2 mm to about 1.0 mm.

30. A method of bonding portions of fabric to one another, the method comprising:
dispensing a plurality of liquified adhesive spots onto a first fabric portion having longitudinal fibers and transverse fibers so that individual ones of the plurality of liquified adhesive spots are spaced apart from one another along a first direction, where the first direction is aligned with either the longitudinal fibers or the transverse fibers; and
applying a second fabric portion to the plurality of liquified adhesive spots dispensed onto the first fabric portion so as to adhere the second fabric portion to the first fabric portion.

31. The method of claim 30, wherein the dispensing step comprises dispensing the plurality of liquified adhesive spots such that individual ones of the plurality of liquified adhesive spots are spaced apart from one another along a second direction, different from the first direction.

32. The method of claim 31, wherein the first direction and the second direction are angularly offset from one another so as to be non-parallel.

33. The method of claim 32, wherein the first direction is substantially perpendicular to the second direction.

34. The method of claim 30, wherein the dispensing step comprises dispensing the plurality of liquified adhesive spots along the first direction, where the first direction is aligned with either the longitudinal fibers or the transverse fibers.

35. The method of claim 34, wherein:
the dispensing step comprises dispensing the plurality of liquified adhesive spots such that individual ones of the plurality of liquified adhesive spots are spaced apart from one another along a second direction, different from the first direction;
the first direction is aligned with the longitudinal fibers; and
the second direction is aligned with the transverse fibers.

36. The method of claim 30, wherein the dispensing step comprises dispensing the plurality of liquified adhesive spots along the first direction, where the first direction is offset from each of the longitudinal fibers and the transverse fibers by about 45°.

37. The method of claim 36, wherein:
the dispensing step comprises dispensing the plurality of liquified adhesive spots such that individual ones of the plurality of liquified adhesive spots are spaced apart from one another along a second direction, different from the first direction; and
the second direction is offset from each of the longitudinal fibers and the transverse fibers by about 45°.

38. The method of claim 30, wherein the first fabric portion is a woven fabric having a warp and a weft, the warp including one of the longitudinal fibers and the transverse fibers and the weft including the other of the longitudinal fibers and the transverse fibers, and wherein the dispensing step comprises dispensing the plurality of liquified adhesive spots along the first direction, where the first direction is aligned with either the warp or the weft.

39. The method of claim 30, wherein the first fabric portion is a woven fabric having a warp and a weft, the warp including one of the longitudinal fibers and the transverse fibers and the weft including the other of the longitudinal fibers and the transverse fibers, and wherein the dispensing step comprises dispensing the plurality of liquified adhesive spots along the first direction, where the first direction is offset from each of the warp and the weft by about 45°.

40. The method of claim 30, wherein the first fabric portion is a knitted fabric having courses and wales, the courses including one of the longitudinal fibers and the transverse fibers and the wales including the other of the longitudinal fibers and the transverse fibers, and wherein the dispensing step comprises dispensing the plurality of liquified adhesive spots along the first direction, where the first direction is aligned with either the courses or the wales.

41. The method of claim 30, wherein the first fabric portion is a knitted fabric having courses and wales, the courses including one of the longitudinal fibers and the transverse fibers and the wales including the other of the longitudinal fibers and the transverse fibers, and wherein the dispensing step comprises dispensing the plurality of liquified adhesive spots along the first direction, where the first direction is offset from each of the courses and the wales by about 45°.

42. A fabric article, comprising:
a first fabric portion having longitudinal fibers and transverse fibers and a plurality of adhesive spots dispensed thereon such that individual ones of the plurality of adhesive spots are spaced apart from one another so as to define a plurality of unbonded gaps between the adhesive spots, wherein (i) a portion of at least one longitudinal fiber, (ii) a portion of at least one transverse fiber, or (iii) a portion of at least one longitudinal fiber and a portion of at least one transverse fiber extends through each of the unbonded gaps and is unbonded by adhesive; and
a second fabric portion adhered to the first fabric portion by the plurality of adhesive spots.

43. The article of claim 42, wherein individual ones of the plurality of adhesive spots are spaced from one another along each of a first direction and a second direction, different from the first direction.

44. The article of claim 43, wherein the first direction and the second direction are angularly offset from one another so as to be non-parallel.

45. The article of claim 44, wherein the first direction is substantially perpendicular to the second direction.

46. The article of claim 43, wherein the first direction is aligned with the longitudinal fibers and the second direction is aligned with the transverse fibers.

47. The article of claim 43, wherein the first direction is offset from each of the longitudinal fibers and the transverse fibers by about 45° and the second direction is offset from each of the longitudinal fibers and the transverse fibers by about 45°.

48. The article of claim 42, wherein the first fabric portion is a woven fabric having a warp and a weft, the warp including one of the longitudinal fibers and the transverse fibers and the weft including the other of the longitudinal fibers and the transverse fibers.

49. The article of claim 42, wherein the first fabric portion is a knitted fabric having courses and wales, the courses including one of the longitudinal fibers and the transverse fibers and the wales including the other of the longitudinal fibers and the transverse fibers.

50. The article of claim 42, wherein the first fabric portion has the plurality of adhesive spots dispensed thereon along a length so that individual ones of the plurality of spots are spaced from one another along a dispensed line requiring at least 30% less adhesive as compared to a solid line having the same length.

51. A method of bonding portions of fabric to one another, the method comprising:
dispensing a first plurality of liquified adhesive spots onto a first fabric portion so that individual ones of the first plurality of liquified adhesive spots are spaced apart from one another along a first direction so as to define a first plurality of unbonded gaps between the first plurality of liquified adhesive spots;
dispensing a second plurality of liquified adhesive spots onto the first fabric portion so that individual ones of the second plurality of liquified adhesive spots are spaced apart from one another along the first direction so as to define a second plurality of unbonded gaps between the second plurality of liquified adhesive spots, wherein individual ones of the second plurality of liquified adhesive spots are spaced apart from individual ones of the first plurality of liquified adhesive spots and aligned with individual ones of the first plurality of unbonded gaps; and
applying a second fabric portion to the first and second pluralities of liquified adhesive spots dispensed onto the first fabric portion so as to adhere the second fabric portion to the first fabric portion.
